(19) United States
(12) Patent Application Publication
(10) Pub. No.: US 2011/0077926 A1
(43) Pub. Date: Mar. 31, 2011

(54) SIMULATION SYSTEM AND METHOD FOR A TECHNICAL INSTALLATION

(75) Inventors: Karl-Josef Amthor, Munchen (DE); Hans-Georg Köpken, Erlangen (DE); Thilo Stolper, Nurnberg (DE)

(73) Assignee: Siemens Aktiengesellschaft, Munchen (DE)

(21) Appl. No.: 12/893,518

(22) Filed: Sep. 29, 2010

(30) Foreign Application Priority Data
Sep. 29, 2009 (DE) 10 2009 043 425.9

(51) Int. Cl. G06G 7/48

(52) U.S. Cl. 703/6

(57) ABSTRACT

A simulation system has a first simulator for simulating a first physical process and configured to store first CAD-based data, a second simulator for simulating a second physical process and configured to store second CAD-based data, and a server configured to process the first CAD-based data from the first simulator and to process the second CAD-based data from the second simulator.

### CROSS-REFERENCES TO RELATED APPLICATIONS

This application claims the priority of German Patent Application, Serial No. 10 2009 043 425.9, filed Sep. 29, 2009, pursuant to 35 U.S.C. 119(a)-(d), the content of which is incorporated herein by reference in its entirety as if fully set forth herein.

### BACKGROUND OF THE INVENTION

The present invention relates to a simulation system and method for a technical installation, such as a machine or a factory.

The following discussion of related art is provided to assist the reader in understanding the advantages of the invention, and is not to be construed as an admission that this related art is prior art to this invention.

In a digital factory, different aspects of an installation or a machine can be simulated by different simulation tools. For example, a material flow in the installation is modeled in a first simulation tool and the kinematics of an automatic handling machine is modeled in a second simulation tool. The simulation tools are independent of one another.

It would therefore be desirable and advantageous to provide an improved simulation system and method for a technical installation, a machine or a factory which obviates prior art shortcomings and links the simulation tools with one another for exchange of data.

### SUMMARY OF THE INVENTION

According to one aspect of the present invention, a simulation system includes a first simulator for simulating a first physical process and configured to store first CAD-based data, a second simulator for simulating a second physical process and configured to store second CAD-based data, and a server configured to process the first CAD-based data from the first simulator and to process the second CAD-based data from the second simulator.

According to another aspect of the invention, a simulation method for simulating physical processes includes the steps of simulating a first physical process and processing first CAD data with a first simulator, simulating a second physical process and processing second CAD data with a second simulator, and processing with a server data from the first simulator and data from the second simulator.

In order to improve a simulation, at least two simulation tools can be designed in such a manner that these simulation tools interchange data with one another, results from individual simulation tools also being able to be combined, in particular. An aim of the simulation may be, for example, to clarify interaction between an automatic handling machine and a process material. This relates, for example, to packaging machines, printing machines, inking devices in printing machines, presses, woodworking machines, glass processing machines, installations for producing products of different types and with different characteristics such as washing machines, automobiles, electric motors, ABS housings or electronic articles.

A simulation system has the following components, for example:
a first simulator for simulating a first physical process;
a second simulator for simulating a second physical process; and
a server, in particular an object server, for processing data from the first simulator and for processing data from the second simulator.

CAD data are stored in the first simulator and in the second simulator. CAD data originate from a CAD system (Computer Aided Design system). CAD data relate to a geometry description. In one refinement, the server may have transformation rules. One or more transformation rules can be used to determine states on the basis of other states. For example, a state from the first simulator can thus be transformed into a comparable state of the second simulator. Simulators can therefore be adapted to one another.

According to one variant of the simulation system, CAD data are stored in the object server. The server is, in particular, a rich object server. CAD data can be transmitted from the server to one simulator or else to a multiplicity of simulators. If different simulators require different CAD data, the server transmits, to one of the simulators, CAD data which are specifically required for this specific simulator.

According to one variant of the simulation system, a plug-in is stored in the server. The plug-in is a software expansion module for a computer program whose functionality is expanded thereby. The plug-in is, for example, a plug-in of a simulator or of other software. The plug-in may be present in a DLL format or else as a proprietary data information block. In one embodiment, a first plug-in of the first simulator and a second plug-in of the second simulator are stored in the server. The plug-in may comprise different information such as at least one of the following:
information relating to which data are required by the simulator for a simulation;
information relating to which simulation data are intended to be displayed on a user interface;
information relating to which simulation data are intended to be displayed on a user interface in which manner;
information relating to which attributes of objects (software objects) are required by the simulator;
information relating to which CAD data are to be transmitted to the simulator.

According to one variant of the simulation system, the simulation system has a first signal processing simulator and a second signal processing simulator. A signal processing simulator simulates, for example, a numerical control (NC), a computer numerical control (CNC), a kernel of the NC (NCK), a programmable logic controller (PLC), a motion controller, a drive controller, etc.

The first signal processing simulator is intended, for example, to process data from the first simulator, the second signal processing simulator being intended to process data from the second simulator. The first and second signal processing simulators simulate a control function and/or a regulating function.

According to one variant of the simulation system, at least one signal processing simulator has CAD data. These CAD data may relate to axial dimensions, sizes or else identification data of components, for example. The CAD data in the signal processing simulators may have been transmitted from the server (for example an object server) directly or else indirectly via simulators for simulating movements of mechanical objects. The first simulator and/or the second simulator can be designed as such simulators. When indirectly transmitting CAD data to a signal processing simulator, the CAD data are first of all transmitted to the first simulator, for example. The CAD data are transmitted from the first simulator to the signal processing simulator.

According to one variant of the simulation system, the system has a time manager. The time manager controls or regulates functions of different simulators. Signal processing simulators can also be coordinated and/or controlled by the time manager on a time-related basis in relation to one another. The time manager makes it possible, for example, to match different functions or simulation steps of different simulators (for example for mechanical operations or else for signal processing operations) to one another. The time manager can therefore be used as a synchronizer for a multiplicity of simulators. In one variant, the time manager is linked, for data processing purposes, both to simulators and to one or more object servers which are in turn connected, for data processing purposes, to the simulators. The time manager may also be integrated in the server.

According to one variant of the simulation system, a physical object is represented by a software object in the simulation system. Examples of physical objects are production goods (for example a housing, a bottle, a tubular bag, an electronic subassembly, an automobile, etc.). The software object has at least one attribute, the attribute being used to describe the physical object. If the physical object is a bottle, for example, the software object may have an attribute for the following descriptive features: size, shape, material, color, location in the plane, location in space, temperature, age, degree of wear, etc.

According to one variant of the simulation system, the object server manages attributes of software objects. This has the advantage of central data management. The object server also stores which of the simulators requires which attributes for which software object. There are applications in which not every simulator requires all information relating to all attributes. The object server can therefore be designed in such a manner that it transmits, to a simulator (in particular also a signal processing simulator), only those attributes of a software object which are required by the simulator for the simulation to be carried out.

According to a simulation method for simulating physical processes, different simulators can be linked to one another. Examples of physical processes are listed below:
moving a body
heating a body
cooling a body
processing a body (turning, milling, grinding, polishing, bending, stamping, rolling, molding, spraying, coating, doping, etc.).

In the simulation method, the following measures can be carried out individually or together, for example:
a first simulator is used to simulate a first physical process;
a second simulator is used to simulate a second physical process;
a server (in particular an object server) is used to process data from the first simulator and data from the second simulator;
CAD data are processed in the first simulator; and
CAD data are processed in the second simulator.

Simulation results from the first simulator are advantageously transmitted to the server. Data in the server which depend on the simulation results from the first simulator can then be transmitted to the second simulator, for example. These data can then be used for an additional simulation in the second simulator. The chronological sequence in which the data are transmitted can advantageously be effected using a time manager.

The CAD data which are processed in the first and second simulators have advantageously been transmitted from the server to the simulators. The server received the CAD data from a CAD system, for example via a network connection, via the Internet. The CAD data are therefore centrally managed in the server for different simulators.

The simulation method can be expanded and supplemented according to the above description of the simulation system.

According to one variant of the simulation method, CAD data are stored and/or processed in the server, data being interchanged between the server and the first simulator, and data being interchanged between the server and the second simulator. Attributes for software objects which are used in the first simulator are advantageously stored in the server. Furthermore, attributes for software objects which are used in the second simulator or in further additional simulators can also be stored in the server. If software objects of different simulators correspond to one another, they can be combined in the server, the server storing the attributes of the corresponding software objects and providing the respective specifically required attribute contents if necessary.

According to one variant of the simulation method, a first signal processing simulator is used to process data from the first simulator. A second signal processing simulator is used to process data from the second simulator, a control function being simulated using the first and second signal processing simulators, and the first signal processing simulator and/or the second signal processing simulator simulating functions of at least one of the devices listed below:
a programmable logic controller (PLC);
a numerical control (NC or CNC);
a drive device (for example an inverter, a converter, a motion controller, etc.).

According to one variant of the simulation method, the object server manages software objects, the software objects having attributes, a software object having a multiplicity of attributes, and the object server transmitting different attributes of a software object to the different simulators depending on the simulator.

According to one variant of the simulation method, the first simulator simulates transport of a physical object. The second simulator simulates processing or use of the physical object for something. In the case of tubular bag packaging machines, a tubular bag, for example, can be filled with a filling material, which can be simulated by a simulator.

According to one variant of the simulation method, simulation results are transmitted from the first simulator to the second simulator in a chronologically ordered manner.

According to one variant of the simulation method, simulation results from the signal processing simulators are processed in a data transmission simulator. The data processed in the data transmission simulator are processed further in the first simulator and/or in the second simulator. It goes without saying that the number of simulators is not restricted to one first simulator and one second simulator either here in this example or in the other examples described. A system may have a multiplicity of simulators, that is to say also more than two.

In one refinement of the system, the rich object server adds at least one attribute to an object which is received by the server from a CAD application. For example, an attribute for a respective state is added to each object in the structure. Simulation systems and global functions can be designed in such a manner that they can interrogate and/or set the attributes.

A simulation system may use a rich object server to interchange data between the simulation tools and the global functions, the visualization, the acquisition of input data, the plotting of results and the logging. The rich object server can adopt the structure of the CAD data relating to the installation or machine. In this case, the server adds attributes for the respective states to each object in the structure, for example. Simulation systems and global functions can interrogate or set these attributes. In addition, the rich object server also has transformation rules, for example. Said transformation rules can be used to determine states on the basis of other states. Data can be centrally managed and centrally interchanged via the rich object server. The data structure in the rich object server can be based on the CAD data structure. Data can therefore be continuously interchanged between the simulation tools, in which case it is also possible to collect the data for central functions such as viewers, logger scopes and data inputs. A corresponding memory apparatus is provided for the purpose of managing the states of all simulation objects, in particular, with their CAD data structure in the rich object server. Each simulation tool advantageously regularly transfers the states of its simulation objects, which are to be interchanged, to the rich object server, each simulation tool being able to interrogate the states of individual objects in the rich object server. In addition, global programs can access the rich object server in order to interrogate the relevant properties of all objects.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a diagrammatic structure of a simulation system, from which a corresponding simulation method can be derived;

FIG. 2 shows a practical exemplary application; and

FIG. 3 shows software objects with associated attributes.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

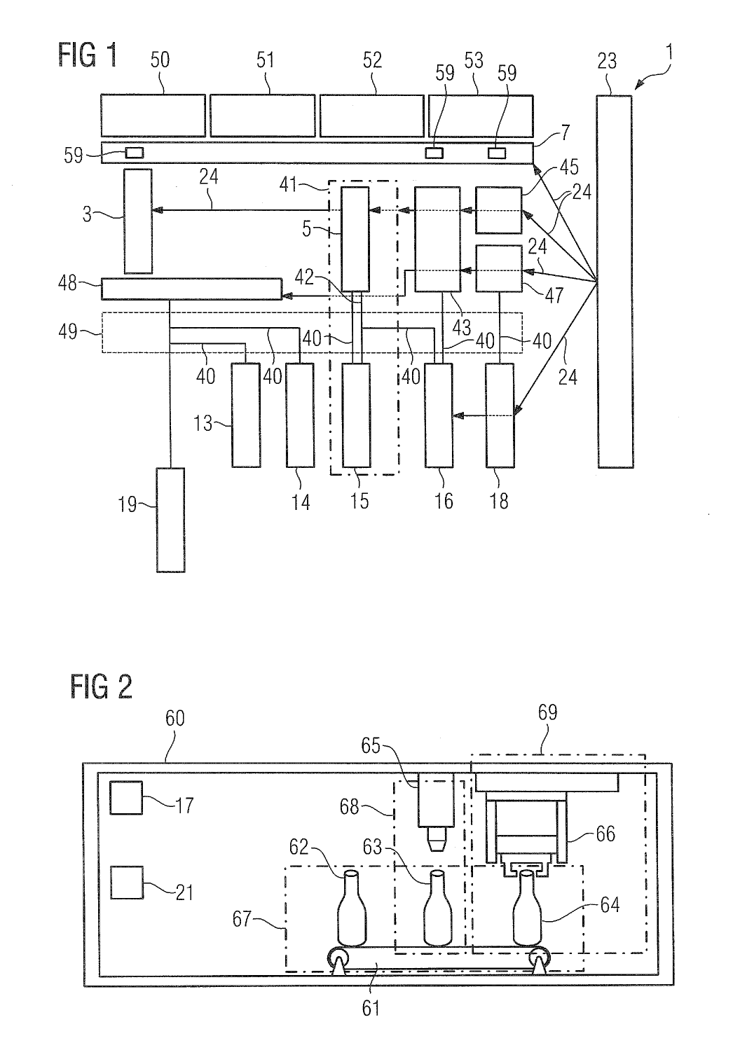

Turning now to the drawing, and in particular to FIG. 1, there is shown a simulation system 1. The simulation system has a first simulator 3, a second simulator 5, a third simulator 43, a fourth simulator 45 and a fifth simulator 47. One of the simulators simulates a transport device for transporting a goods item, for example. A further simulator simulates, for example, a device such as a Sinamic®. These simulators 3, 5, 43, 45 and 47 are simulation tools for simulating a wide variety of operations which can usually be associated with a mechanical/physical/chemical operation.

Physics engines are one example of simulators. A physics engine is software or a combination of software and hardware which, as a type of physics module, is used to simulate a physical process and to calculate object-intrinsic properties (for example a pulse). An aim may also be to simulate environmental conditions or the like. Simulators such as physics engines which have real-time capability are advantageous. The following can be simulated, for example, with the aid of a physics engine:
a physical view of a rigid body (rigid body mechanics)/the physics of rigid bodies use, in particular, the laws of classical mechanics;
collisions between bodies with sudden changes in direction and pulse changes, for example;
mass-spring models;
particle systems, inter alia as the basis for simulating fluids (liquid or gaseous); electrical charges and their interactions.

A rich object server 7 is used in order to be able to interchange data between a multiplicity of simulation tools 3, 5, 43, 45 and 47. A rich object is a software object. This software object is used to manage generic data, for example. The software object may have attributes for this purpose. The rich object server can be used to manage the software objects. The attributes of the rich object depend on the simulation tool 3, 5, 43, 45 and 47 for which the respective rich object is intended. The rich object server 7 is a server which manages and/or stores the rich objects. The rich object server may also be intended, for example, to perform other functionalities, for example data interchange for a function which comprehensively relates to at least two simulation tools. Such a comprehensive, that is to say global, function can be understood as meaning, for example:
a visualization;
acquisition of input data;
plotting of results; or
logging of data.

For this purpose, the simulation system also has, for example, a data input device 50, a plotter (scope) 51, a logger (data logger) 52 and a viewer 53 (man/machine interface, for example a screen).

The rich object server is connected to at least one client. Examples of clients are:
the first simulator 3 or a first device on which the first simulation tool can run;
a second simulator 5 or a second device on which the second simulation tool can run;
an NC controller of a machine tool;
engineering software for creating an application program;
a drive control device.

The rich object server 7 is intended to accept CAD data from an installation or a machine, for example. This acceptance may involve rich objects. The CAD data relate, for example, to a machine or installation behavior, structural dimensions of the machine or installation, dimensions and data of the article(s) manipulated, constructed or processed by the installation or machine, etc.

The rich object server advantageously fully or partially adopts the structure of the CAD data. CAD data may be structured as follows, for example:
in individual body views;
in functional views;
in assembly views (the machine bed, machining tower, spindle, etc. in the case of machine tools, for example).

The rich object server advantageously adds at least one attribute to a software object received by the server from a CAD application. For example, an attribute for a respective state is added to each object in the structure. Simulation systems and global functions can be designed such that they are able to interrogate and/or set the attributes.

Possibilities for interchanging data between simulation tools can be advantageously expanded thereby. This interchange can be implemented, for example, using mechanisms such as OPC, ODE, COM/DCOM or CORBA. Data interchange can also be planned per se if central objects which do not have an implicit data structure per se are used. All variables and also the data structures must then be separately defined. In this case, it should be ensured that these remain consistent and comprehensible. This is simplified and is a more efficient solution when using the rich object server with the attributes for the objects. This holds true, in particular, because the coupling interfaces are only rudimentary between a large number of tools. Functionalities must therefore be implemented by the user, for example as C code. In addition, there are restrictions in the individual mechanisms, inter alia in terms of the cycle times and the data flow directions. In this case, the issue of the “virtual time axis” is likewise taken into account only rudimentarily in some applications. In order to interchange data between the individual tools, there is therefore a need for an intermediate entity in order to bridge different cycle times and avoid waiting times. The JT format is used as one of the interchange formats for CAD data. In this case, it is also possible to concomitantly model the kinematics and to use the latter to visualize simulations.

The disadvantages described above can be overcome using a central component such as the rich object server 7. The individual simulation tools 3, 41, 43, 45 and 47 and the tools for implementing global functions 50, 51, 52 and 53 communicate with the server 7.

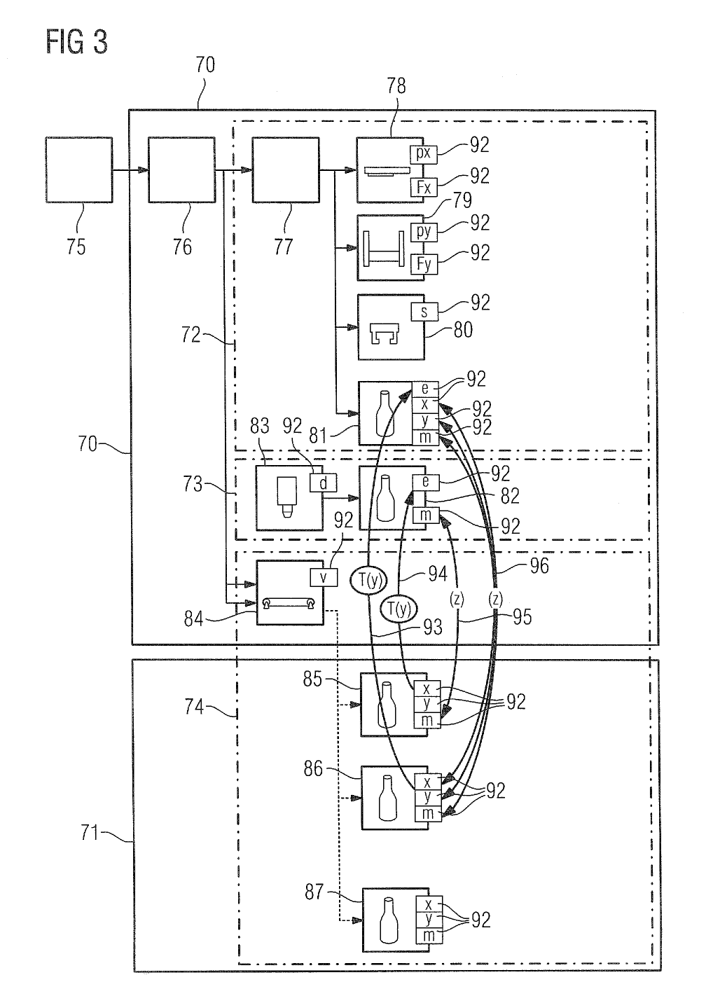

The rich object server 7 constructs its data structure by importing CAD data. The illustration according to FIG. 3 shows an example of an object model for a simulation scenario in the server 7. In this case, the server adopts the object structures from CAD data. If a simulation tool would like to store a state of an object, the rich object server creates an attribute for the corresponding object 87 or updates the corresponding attribute directly on the corresponding CAD object. In this case, the server 7 also manages the information relating to objects 85, 86 and 87 which are dynamically generated at the runtime, such as the process material objects, by loading a separate entity of the respective CAD record for each of these objects.

In one advantageous refinement, each simulation tool 3, 41, 43, 45, 47, 48, 49, 13, 14, 15, 16 and 18 can have both write and read access to all attributes 92 of all objects. The individual simulation tools 3, 41, 43, 45, 47, 48, 49, 13, 14, 15, 16 and 18 have, for example, domain-specific models such as the kinematics, inter alia. They transfer their results to the rich object server 7 at the runtime. Multi-domain simulations are thus produced using the coordinated rich object server.

Tools for global functions 50, 51, 52 and 53 are attached to the rich object server 7. In this case, it is possible to implement the functions of visualization, acquisition of input data, plotting of results and logging. These functions can be supplied with temporally consistent data as a result of the central data management. In this case, it is possible to directly adopt the attributes of the objects from the rich object server for the positions, orientations, colors and transparency of the objects for the visualization since the object structures may be identical here.

As the illustration according to FIG. 1 shows, the rich object server 7 has plug-ins 59. These plug-ins 59 originate from simulators or relate to the latter, for example. The simulators 3, 5, 43, 45, 47, 16, 18 can be temporally controlled by a time manager 23. Time management data 24 are used for this purpose.

The system 1 may also have a real-time unit 41. The real-time unit 41 illustrated in FIG. 1 has the second simulator 5 and the second signal processing simulator 15. These two simulators are connected to one another via a real-time communication path 42. The different simulators of the system are also connected to one another using further communication paths 40. This forms a communication network 49 which can also be simulated.

An OPC server 48, a numerical control 19, a first signal processing simulator 13 (for example for a virtual NC kernel), a second signal processing simulator 14 (for example for a virtual programmable logic controller), a third signal processing simulator 15 (for example for a virtual motion controller), a fourth signal processing simulator 16 (for example for a simulated/emulated programmable logic controller) and a fifth signal processing simulator 18 are also concomitantly incorporated in the communication network.

The illustration according to FIG. 2 diagrammatically shows a simulation scenario for a bottle filling device 60. A process of filling bottles therefore needs to be simulated. In accordance with the simulation scenario according to FIG. 2, the process material elements are bottles 62, 63 and 64 which can be represented by objects, these objects being able to have attributes such as a bottle size, for example. Transformations between the objects of a dynamic submodel and a static submodel of the data model in the rich object server may be required for these, as also illustrated in FIG. 3. FIG. 1 has already outlined a possible structure of the overall simulation system. In this case, the data are interchanged between the simulation systems 3, 41, 43, 45 and 47 by means of the rich object server. The simulation systems can communicate with the controllers 13, 14, 15, 16 or 18 directly or else indirectly via a simulated or real communication network 49. ProfiNet is one example of a communication network. Time slices can be coordinated using a central time manager 23 for the purpose of communication.

The illustration according to FIG. 2 shows that the bottles 62, 63, 64 can be transported to a bottle filling machine 65 by means of a conveyor belt 61. A filling system 68 is formed in this manner. This system can be assigned, for example, a function: m=f(d). A bottle 64 can also be transported to a manipulator system 69 using the conveyor belt 61. The manipulator system 69 has a manipulator 66. This system can also be assigned functions, for example: (x, y)=f(px, py); (Fx, Fy)=f(m). In addition to this manipulator system 69, there is also a drive device 21 and a programmable logic controller 17. A material flow of bottles 62, 63 and 64 can be simulated by a transport system 67.

The illustration according to FIG. 3 shows an operation of dealing with software objects and the associated attributes. The rich object server 7 combines the information relating to the models from the different simulation tools with different abstraction levels. In this case, it also forms the bridge for the information from dynamic and static models. Transformation rules 93, 94 are stored in the rich object server 7 for this purpose. The transformation rules are described by mathematical, logical and transfer functions. These transformation rules 93, 94 can be used, on the one hand, to match the information from a dynamic submodel to elements in the static CAD model and, on the other hand, to transform properties between a subassembly and its elements.

The operation of matching the information relating to the elements from a dynamic submodel 71 and elements from the static model 70 (can use a CAD structure) is carried out, for example, by the rich object server 7, inter alia for the process material objects. In this case, the rich object server 7 implements both logical transformation rules 93, 94 and simple transfer transformations 95, 96. The logical transformation rules 93, 94 are used, in an attribute 92 of dummy process material objects 82 in the static object (sub-) model 70, to signal the existence of a process material object 85, 86, 87 from the dynamic submodel 71 at the position of the dummy process material object. In addition, the transfer transformations 95, 96 transfer the properties of the process material objects from the dynamic submodel to the process material objects from the static model if the positions of the two objects are identical. FIG. 3 also illustrates a superordinate system 75 which can interchange data with the submodel 70.

The rich object server also determines the states of subassemblies 77 from states of the respective elements 78, 79 and 80. These elements are already known from FIG. 2. They are an X axis 78, a Y axis 79 and a gripper 80. The elements of the filling station 83 and the transport system are also already known from FIG. 2 (there: the bottle filling machine 65 and the conveyor belt 61). In this case, a transformation rule 93, 94 is implemented, for example, whenever a system interrogates a state to be determined by said rule. In this case, a transformation did not model a behavior description but rather only the transition between the models of the individual simulation tools 3, 41, 43, 45 and 47.

The flexibility of the simulation is now improved by virtue of the fact that the data management is facilitated by expanding the CAD data structure with simulation-specific attributes and dynamic transformations between these attributes.

The practice of tying simulator-specific attributes to the CAD data structure combines the data models from the different simulations in a common data model without having to necessarily change the structure in the individual simulators. The CAD structure is suitable as a common structure since it is produced early in the design process and is clear to all participants. In order to simulate typical installations, both simulation tools with dynamic objects and simulation tools which support only static models are required, for example. The dynamic transformations allow these tools to interact. It is not absolutely necessary to expand the simulators having a static object model with a dynamic object model. The rich object server makes it possible to scale the simulation system by incorporating the simulators required for the specific simulation task. In this case, the system remains transparent as a result of the common data structure and can be controlled and observed using central user interfaces. It is therefore possible to simulate an installation which has, for example as a subassembly 77, a highly kinematic automatic handling machine and a transport system 84 for a process material, such as bottles, and a filling station 83. In this case, the highly kinematic automatic handling machine 77 is controlled by a SIMOTION®, for example, and the transport system 84 for the process material and the filling station 83 are controlled by a SIMATIC®. In this case, the automatic handling machine, the transport system and the filling station are installed on a common carrier (rack) 76. An appropriate simulation scenario is depicted in FIG. 2. Since the automatic handling machine 77 is a highly dynamic system and the filling station 83 is a system having a fixed number of objects with known relationships and the transport system 84 having the process material is a system with a dynamic number of objects which are loosely coupled, these systems are handled in specialized simulation models using specialized simulation systems. A material flow simulation, a filling simulation and a kinematics simulation are used. In this case, the material flow simulation uses a dynamic object model and the filling simulation and the kinematics simulation each use static object models. If questions relating to the manner in which the process material is handled by the automatic handling machine also still need to be clarified, the states of the objects in the installation and of the process material can be transmitted via the central rich object server. In order to manage the objects, the CAD data relating to the installation with dummy process material objects are imported into the rich object server instead of a possible process material object to be handled by the automatic handling machine 77 and instead of a process material object to be filled. These objects form the static part of the object model in the rich object server. In addition, the simulation system dynamically creates an entity in the rich object server for each process material object for the material flow simulation. In this case, the dynamic part 71 is produced in the object model of the rich object server.

In one variation, the rich object server is not aware of any behavior descriptions of the installation or its objects. These behavior descriptions, such as a kinematic model 72, a filling model 73 and a material flow model 74, are known only to the respective simulation systems. Since there may be a discrepancy in the structure of the data to be interchanged between the simulation models, and this is even likely, transformation rules 93, 94 are required. The attribute for the presence of a stationary placeholder object for a process material element which is currently intended to be manipulated is thus stored in a transformation rule 93, 94, for example with the values true and false. In this case, the attribute assumes the value true only when an actually existing, identical element of the material flow is at precisely the same position. The properties are synchronized between the two objects in a further transformation rule or in a transfer transformation 95, 96. This makes it possible to overcome the different nature of the static object model of the automatic handling machine 77 or of the filling station 83 and the dynamic object model, that is to say the dynamic plane 71 of the material flow.

As also illustrated in FIG. 1, the visualization, the acquisition of input data, the plotting of results and the logging can be centrally carried out on the basis of the rich object server. This makes it possible to synchronously supply the different simulation systems with input data and to evaluate the interaction between the automatic handling machine and the process material. In this case, the different simulation systems relate, for example, to the static simulation model and the dynamic simulation model or else a physics/kinematics system and a system for modeling one or more control/regulating systems.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A simulation system comprising:
a first simulator for simulating a first physical process and configured to store first CAD-based data,
a second simulator for simulating a second physical process and configured to store second CAD-based data, and
a server configured to process the first CAD-based data from the first simulator and to process the second CAD-based data from the second simulator.

2. The simulation system of claim 1, wherein the server is an object server.

3. The simulation system of claim 1, wherein the server stores CAD data.

4. The simulation system of claim 1, wherein the server stores a first plug-in of the first simulator and a second plug-in of the second simulator.

5. The simulation system of claim 1, further comprising a first signal processing simulator configured to process data from the first simulator and to simulate a first control or regulating function, and a second signal processing simulator configured to process data from the second simulator and to simulate a second control or regulating function.

6. The simulation system of claim 5, wherein at least one of the first signal processing simulator and the second signal processing simulator simulates a function of at least one a programmable logic controller, a numerical control, and a drive device.

7. The simulation system of claim 5, further comprising a time manager controlling or regulating the first and second simulator and the first and second signal processing simulator.

8. The simulation system of claim 1, wherein the simulation system comprises a software object representing a physical object, said software object having at least one attribute which describes the physical object.

9. The simulation system of claim 8, wherein the server manages attributes of software objects.

10. A simulation method for simulating physical processes, comprising the steps of:
simulating a first physical process and processing first CAD data with a first simulator,
simulating a second physical process and processing second CAD data with a second simulator, and
processing with a server data from the first simulator and data from the second simulator.

11. The simulation method of claim 10, wherein the server is an object server.

12. The simulation method of claim 10, further comprising the steps of:
at least one of storing and processing in the server the first and second CAD data, and
interchanging the data between the server and the first simulator, and between the server and the second simulator.

13. The simulation method of claim 10, further comprising the steps of:
processing the data from the first simulator with a first signal processing simulator,
processing the data from the second simulator with a second signal processing simulator,
simulating a first control function or a regulating function with the first signal processing simulator, and
simulating a second control function or a regulating function with the second signal processing simulator,
wherein the first signal processing simulator or the second signal processing simulator, or both, simulate functions of at least one of a programmable logic controller, a numerical control, and a drive device.

14. The simulation method of claim 10, further comprising the steps of:
managing software objects with the server, with a software object having a plurality of attributes, and
transmitting from the server different attributes of a software object to the first and second simulators, wherein the transmitted attributes depend on the simulator to which the different attributes are transmitted.

15. The simulation method of claim 10, wherein the first simulator simulates transporting a physical object and the second simulator simulates processing or using the physical object.

16. The simulation method of claim 10, wherein simulation results are transmitted from the first simulator to the second simulator in chronological order.

17. The simulation method of claim 13, further comprising the steps of:
processing simulation results from the first and second signal processing simulators in a data transmission simulator, and
additionally processing the simulation results processed in the data transmission simulator in the first simulator or in the second simulator, or both.
